(19) United States
(12) Patent Application Publication
(10) Pub. No.: US 2024/0333543 A1
(43) Pub. Date: Oct. 3, 2024

(54) COGNITIVE MANAGEMENT OF VIRTUAL MEETINGS

(71) Applicant: International Business Machines Corporation, Armonk, NY (US)

(72) Inventors: William Ogallo, Nairobi (KE); Julian Bertram Kuehnert, Nairobi (KE); Isaiah Mulang' Onando, Nairobi (KE); Aisha Walcott, Nairobi (KE); Sekou Lionel Remy, Nairobi (KE); Charles Muchiri Wachira, Karatina (KE)

(73) Assignee: International Business Machines Corporation, Armonk, NY (US)

(21) Appl. No.: 18/129,983

(22) Filed: Apr. 3, 2023

(51) Int. Cl. H04L 12/18

(52) U.S. Cl. CPC H04L 12/1818

(57) ABSTRACT

An embodiment associates a virtual-meeting host designation with a first user. During the virtual meeting, the embodiment generates meeting context data that includes user characteristic data and meeting characteristic data. The embodiment uses the meeting context data to generate a predicted end time for the virtual meeting and predicts a meeting run-over condition indicative of the virtual meeting continuing past a scheduled end time by comparing the predicted end time and a scheduled end time. Responsive to predicting the meeting run-over condition, the embodiment uses the user characteristic data to generate a ranked list of other users and renders, as a display to the first user, the ranked list and an indication of the meeting run-over condition. The embodiment receives a selection of a second user as a new host of the virtual meeting and, responsive to receiving the selection, associates the host designation with the second.

### BACKGROUND

The present invention relates generally to virtual meetings. More particularly, the present invention relates to a method, system, and computer program for cognitive management of virtual meetings.

Virtual meetings continue to become an increasingly popular way for two or more individuals to communicate over long distances. Virtual meetings may be enabled by a variety of different virtual meeting applications. In general, virtual meeting applications allow users to engage in audio and/or video conferencing, share files, presentations, virtual white boards, desktops, and other data while simultaneously conducting voice communications.

A person wishing to host a virtual meeting (the “host”) operates virtual meeting software to create and send meeting invitations to other users with information about how to join the virtual meeting, the time and date, the duration, topic, and other relevant information. Once a user is connected to the virtual meeting, the user is considered an attendee. The virtual meeting software usually allows the host to have control of the meeting by granting the host additional permissions compared to other attendees. For example, it is common for only the host to be able to record meetings, limit attendees, mute other attendees, enable screen-sharing, etc.

### SUMMARY

The illustrative embodiments provide for cognitive management of virtual meetings. An embodiment includes associating, during a virtual meeting attended by a first user, a host designation with the first user, where the host designation designates the first user as the host of the virtual meeting. The embodiment also includes generating, during the virtual meeting, meeting context data associated with the virtual meeting, where the meeting context data comprises user characteristic data and meeting characteristic data. The embodiment also includes generating a predicted end time for the virtual meeting based at least in part on the meeting characteristic data. The embodiment also includes predicting a meeting run-over condition indicative of the virtual meeting continuing past a scheduled end time of the virtual meeting, where the predicting of the meeting run-over condition is based at least in part on a comparison of the predicted end time and the scheduled end time. The embodiment also includes generating, responsive to predicting the meeting run-over condition, a ranked list of other users based at least in part on the user characteristic data. The embodiment also includes rendering, during the virtual meeting as a display to the first user, a virtual meeting environment including the ranked list of the other users and an indication of the meeting run-over condition. The embodiment also includes receiving, from the first user, a selection from the ranked list of a second user as a new host of the virtual meeting. The embodiment also includes associating, responsive to receiving the selection of the second user as the new host, the host designation with the second user such that the host designation designates the second user as the host of the virtual meeting. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example cloud computing environment in accordance with an illustrative embodiment;

FIG. 3 depicts a block diagram of a virtual meeting environment in accordance with an illustrative embodiment;

FIG. 4 depicts a block diagram of an example virtual meeting module in accordance with an illustrative embodiment;

FIG. 5 depicts a block diagram of an example run-over prediction module in accordance with an illustrative embodiment;

FIG. 6 depicts a block diagram of an example user ranking module in accordance with an illustrative embodiment;

FIG. 7 depicts a block diagram of an example host designation module in accordance with an illustrative embodiment;

FIG. 8 depicts a flowchart of an example process for cognitive management of virtual meetings in accordance with an illustrative embodiment;

FIG. 9 depicts a flowchart of an example process for cognitive management of virtual meetings in accordance with an illustrative embodiment;

FIG. 10 depicts a flowchart of an example process for predicting a meeting run-over condition indicative of a virtual meeting continuing past a scheduled end time of the virtual meeting in accordance with an illustrative embodiment;

FIG. 11 depicts a flowchart of an example process for predicting the suitability of other users as hand-off candidates in accordance with an illustrative embodiment; and

FIG. 12 depicts a flowchart of an example process for managing host device designations in accordance with an illustrative embodiment.

### DETAILED DESCRIPTION

During virtual meetings, a host and/or other attendees of a virtual meeting may have schedule conflicts that arise or pre-exist if the meeting runs too long or continues past a scheduled end time of the virtual meeting. In addition to hosting the meeting, the responsibility falls on the host to monitor the progress of the virtual meeting to determine whether the meeting is running according to an agenda or schedule for the virtual meeting. This presents a distraction to the host from being able to fully pay attention to the virtual meeting. Existing virtual meeting applications provide no ability to monitor a virtual meeting to detect if the meeting will run over the scheduled duration.

If the host has another commitment after the scheduled end time of the virtual meeting, further disruption of the meeting may occur once the host realized that the meeting will not be over on time. Existing virtual meeting applications provide no functionality to handle a run-over situation for the host, leaving the host responsible to determine how to best handle the situation, which often requires interrupting the meeting to coordinate with attendees for rescheduling, comparing schedules, etc.

Aspects of the present disclosure address the deficiencies described above by providing mechanisms (e.g., systems, methods, machine-readable media, etc.) that include cognitive management of virtual meetings. An illustrative embodiment intelligently and automatically predicts a meeting run-over condition indicative of a virtual meeting continuing past a scheduled end time of the virtual meeting. An illustrative embodiment offers the host the option of rescheduling or transferring host duties to another user. If the host opts to reschedule, embodiments intelligently and automatically determine recommended times/dates for rescheduling and users to invite. If the host opts to transfer host duties, embodiments predict the suitability of other users as hand-off candidates.

In exemplary embodiments, a process for managing virtual meetings allows user devices to connect with a virtual meeting module that allows the users of the user devices to communicate via audio and/or video via any suitable network or combination of networks such as the Internet, etc. and use any suitable communication protocols such as Wi-Fi, Bluetooth, etc. As a non-limiting example, in an embodiment, a user device executes a routine to initiate a virtual meeting request to the virtual meeting module as the host of the virtual meeting. Any number of other user devices each execute a routine to initiate a request to the virtual meeting module to join the virtual meeting as attendees.

In exemplary embodiments, the process handles a request from the user device to initiate a virtual meeting request as the host of the virtual meeting. The process initially associates a host device designation with the user device. The host device designation of the user device serves to designate the user of the user device as the host of the virtual meeting.

In exemplary embodiments, the process operates during the virtual meeting to generate meeting context data associated with the virtual meeting. The meeting context data comprises user characteristic data and meeting characteristic data. the process stores the user characteristic data and meeting characteristic data in the meeting data database. In some embodiments, the process generates user characteristic data and organizes the user characteristic data into a registry of profiles for the host, the attendees, and other users. In some embodiments, the process generates meeting characteristic data that includes representative states of ongoing virtual meetings. In some embodiments, the meeting and user characteristic data is cognitively evaluated using one or more machine learning techniques for various management aspects of virtual meetings. For example, in some embodiments, the run-over prediction module uses the meeting and user characteristic data to determine run-over likelihood and the process uses the meeting and user characteristic data to identify handoff candidates for hosts/co-hosts recommendations.

In exemplary embodiments, the process predicts a meeting run-over condition indicative of the virtual meeting continuing past a scheduled end time of the virtual meeting. In some embodiments, the process uses the meeting characteristic data to generate a predicted end time for the virtual meeting. In some embodiments, the process predicts the meeting run-over condition by comparing the predicted end time and a scheduled end time.

In exemplary embodiments, the process is triggered by the meeting run-over condition being predicted. The process then predicts the suitability of other users as hand-off candidates. In some embodiments, the process ranks users according to their suitability of taking over the hosting/moderation of a virtual meeting based at least in part on the user characteristic data.

In exemplary embodiments, the process operates during the virtual meeting to render a display of a virtual meeting environment. In some embodiments, the process is triggered by the prediction of the meeting run-over condition to render an alert to the host about the likelihood of the virtual meeting running over. In some embodiments, the process is triggered by the prediction of the meeting run-over condition to render an alert to the other users, including attendees and potential handoff candidates about the likelihood of the virtual meeting running over.

In some embodiments, the process is triggered by the ranking of the users to render the ranked list in the display of the virtual meeting environment. The process rendering of the ranked list provides a visual display of the ranked list of hand-off candidates for a replacement host or cohost of a virtual meeting. In some embodiments, the process rendering of the ranked list includes a visual display of a hand-off suitability score associated with each replacement host/cohost candidate.

In exemplary embodiments, the visual display of the rendering of the ranked list is displayed for the host on the user device. The visual display includes controls that allow the host to select a replacement host from among the displayed ranked list.

In exemplary embodiments, the process receives the selection of the replacement host from the user device. Upon receiving the replacement host selection, the process associates the host device designation with the user device associated with the user selected as the replacement host. The host device designation of the user device serves to designate the user of the user device as the new host of the virtual meeting.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

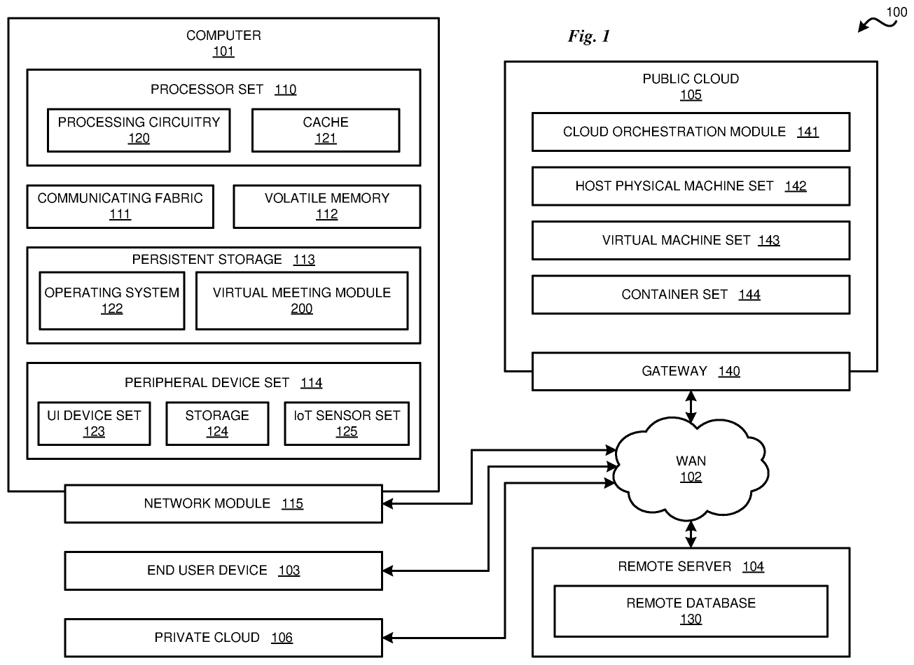

With reference to FIG. 1, this figure depicts a block diagram of a computing environment 100. Computing environment 100 contains an example of an environment for the execution of at least some of the computer code involved in performing the inventive methods, such as an improved virtual meeting module 200 that performs cognitive management of virtual meetings. In addition to virtual meeting module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and virtual meeting module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in virtual meeting module 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in virtual meeting module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

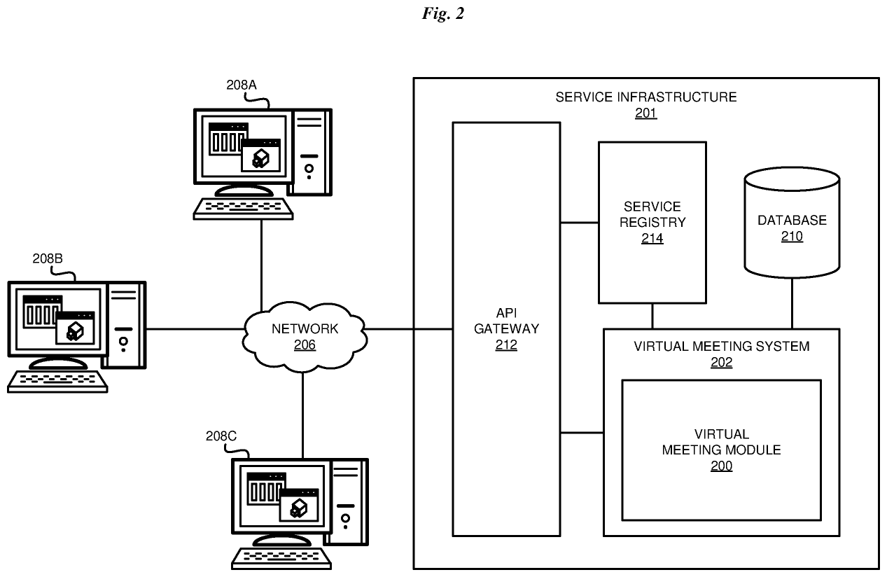

With reference to FIG. 2, this figure depicts a block diagram of an example cloud computing environment in accordance with an illustrative embodiment. In the illustrated embodiment, a service infrastructure 201 includes a virtual meeting system 202, which comprises the virtual meeting module 200 of FIG. 1.

In the illustrated embodiment, the user devices 208A-208C are associated with respective attendees of a virtual meeting that is managed by the virtual meeting module 200. The user devices 208A-208C communicate with the virtual meeting module 200 by connecting with the service infrastructure 201 across one or more networks—shown generally as network 206—via an API gateway 212. In some embodiments, the service infrastructure 201 uses a distributed microservice architecture. In some such embodiments, the virtual meeting module 200 is a microservices-based application that runs as a distributed system across one or more servers. In various embodiments, service infrastructure 201 and its associated virtual meeting system 202 serve multiple users and multiple tenants. A tenant is a group of users (e.g., a company) who share a common access with specific privileges to the software instance. Service infrastructure 201 ensures that tenant specific data is isolated from other tenants.

In some embodiments, user devices 208A-208C connect with API gateway 210 via any suitable network or combination of networks such as the Internet, etc. and use any suitable communication protocols such as Wi-Fi, Bluetooth, etc. Service infrastructure 201 may be built on the basis of cloud computing. API gateway 212 provides access to client applications like virtual meeting system 202.

API gateway 212 receives service requests issued by client applications, and creates service lookup requests based on service requests. As a non-limiting example, in an embodiment, a user device 208A executes a routine to initiate a virtual meeting request to the virtual meeting system 202 as the host of the virtual meeting. Any number of other user devices, such as user device 208B and user device 208C, each execute a routine to initiate a request to the virtual meeting system 202 to join the virtual meeting as attendees. In some situations, the host and/or other attendees of the virtual meeting have schedule conflicts if the meeting runs too long or continues past a scheduled end time of the virtual meeting. The virtual meeting module 200 monitors the progress of the virtual meeting to determine a run-over likelihood, which is a likelihood that the virtual meeting will continue past the schedule conflicts or past the scheduled end time of the virtual meeting. In some embodiments, the virtual meeting module 200 notifies the host of the predicted run-over condition and offers the host options for handling the run-over condition. One option may be to schedule a time to complete the meeting, including recommendations for times/dates to schedule the meeting and attendees to invite. Another option may be to select another user to host the remainder of the meeting, including a recommendation of another user to take over as host for the remainder of the meeting.

In the illustrated embodiment, the service infrastructure 201 also includes, or is otherwise associated with, a database 210 that comprises at least one computer readable storage medium that stores computer readable program instructions (e.g., computer readable program instructions can include, but are not limited to, instructions for performing processes disclosed herein), and can store any data generated and/or used by virtual meeting system 202 and associated components. In some embodiments, the virtual meeting system 202 is an example of the computer 101 of FIG. 1 and includes processing circuitry such as processing circuitry 120 that executes computer readable program instructions.

In the illustrated embodiment, service infrastructure 201 includes a service registry 214. In some embodiments, service registry 214 looks up service instances of virtual meeting system 202 in response to a service lookup request such as one from API gateway 212 in response to a service request from user devices 208A-208C. For example, in some embodiments, the service registry 214 looks up service instances of virtual meeting system 202 in response to requests related to virtual meetings from the user devices 208A-208C.

In some embodiments, the service infrastructure 201 includes one or more instances of the virtual meeting system 202. In some such embodiments, each of the multiple instances of the virtual meeting system 202 run independently as multiple computing systems. In some such embodiments, virtual meeting system 202, as well as other service instances of virtual meeting system 202, are registered in service registry 214.

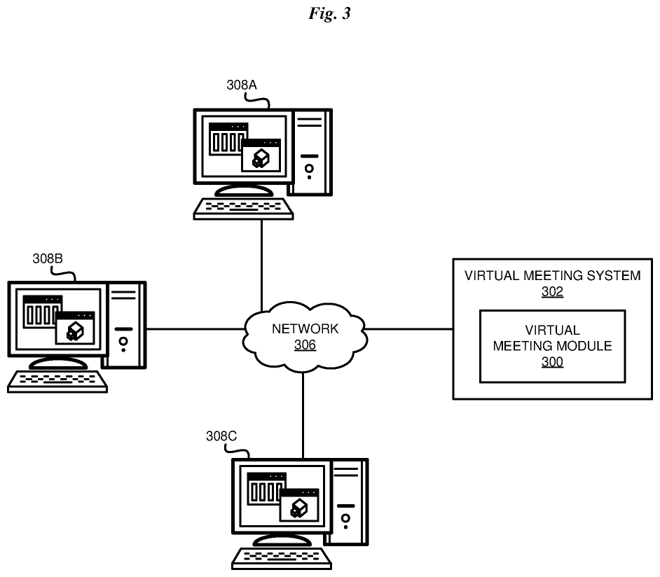

With reference to FIG. 3, this figure depicts a block diagram of a virtual meeting environment in accordance with an illustrative embodiment. In a particular embodiment, a virtual meeting system 302 includes the virtual meeting module 200 of FIG. 1. In some embodiments, the virtual meeting system 302 is an example of the computer 101 of FIG. 1.

In the illustrated embodiment, the user devices 208A-208C are associated with respective attendees of a virtual meeting that is managed by the virtual meeting module 200. The user devices 208A-208C communicate with the virtual meeting module 200 by connecting with the virtual meeting system 302, which is a network accessible device such as a server. In various embodiments, the virtual meeting system 302 is a server configured to serve multiple users.

In some embodiments, user devices 308A-308C connect with virtual meeting system 302 via any suitable network 306 or combination of networks such as the Internet, etc. and use any suitable communication protocols such as Wi-Fi, Bluetooth, etc. The virtual meeting system 302 comprises a virtual meeting module 300, which is an example of the virtual meeting module 200 of FIGS. 1 and 2. In some embodiments, the virtual meeting module 300 receives virtual meeting requests from client applications and processes the virtual meeting requests as described herein. As a non-limiting example, in an embodiment, a user device 308A executes a routine to initiate a virtual meeting request to the virtual meeting system 302 as the host of the virtual meeting. Any number of other user devices, such as user device 308B and user device 308C, each execute a routine to initiate a request to the virtual meeting system 302 to join the virtual meeting as attendees.

In some situations, the host and/or other attendees of the virtual meeting have schedule conflicts if the meeting runs too long or continues past a scheduled end time of the virtual meeting. The virtual meeting module 300 monitors the progress of the virtual meeting to determine a run-over likelihood, which is a likelihood that the virtual meeting will continue past the schedule conflicts or past the scheduled end time of the virtual meeting. In some embodiments, the virtual meeting module 300 notifies the host of the predicted run-over condition and offers the host options for handling the run-over condition. One option may be to schedule a time to complete the meeting, including recommendations for times/dates to schedule the meeting and attendees to invite. Another option may be to select another user to host the remainder of the meeting, including a recommendation of another user to take over as host for the remainder of the meeting.

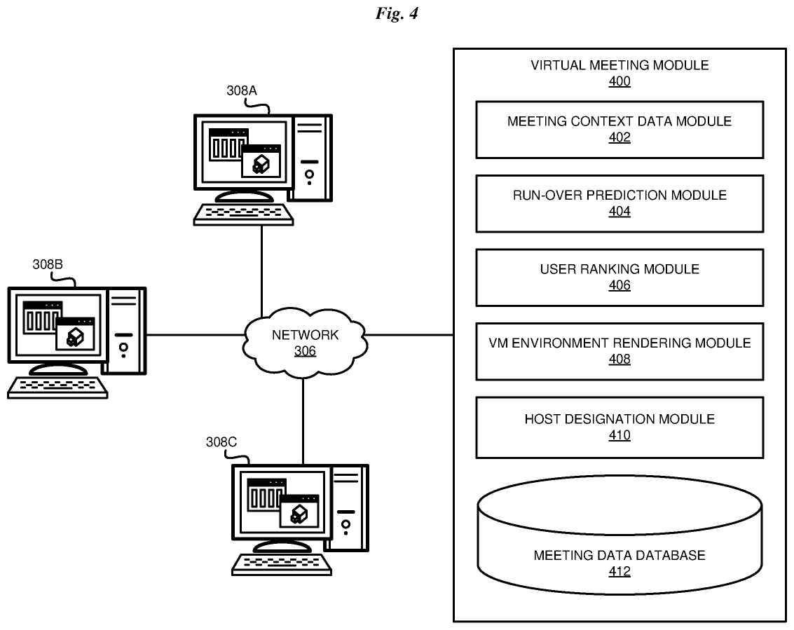

With reference to FIG. 4, this figure depicts a block diagram of an example virtual meeting module 400 in accordance with an illustrative embodiment. In a particular embodiment, the virtual meeting module 400 is an example of the virtual meeting module 200 of FIGS. 1 and 2 or the virtual meeting module 300 of FIG. 3.

In some embodiments, the virtual meeting module 400 includes a meeting context data module 402, a run-over prediction module 404, a user ranking module 406, a virtual meeting (VM) environment rendering module 408, a host designation module 410 and a meeting data database 412. In alternative embodiments, the virtual meeting module 400 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, user devices 308A-308C connect with virtual meeting module 400 via any suitable network 306 or combination of networks such as the Internet, etc. and use any suitable communication protocols such as Wi-Fi, Bluetooth, etc. As a non-limiting example, in an embodiment, a user device 308A executes a routine to initiate a virtual meeting request to the virtual meeting module 400 as the host of the virtual meeting. Any number of other user devices, such as user device 308B and user device 308C, each execute a routine to initiate a request to the virtual meeting module 400 to join the virtual meeting as attendees.

In some situations, the host and/or other attendees of the virtual meeting have schedule conflicts if the meeting runs too long or continues past a scheduled end time of the virtual meeting. The virtual meeting module 400 monitors the progress of the virtual meeting to determine a run-over likelihood, which is a likelihood that the virtual meeting will continue past the schedule conflicts or past the scheduled end time of the virtual meeting. In some embodiments, the virtual meeting module 400 notifies the host of the predicted run-over condition and offers the host options for handling the run-over condition. One option may be to schedule a time to complete the meeting, including recommendations for times/dates to schedule the meeting and attendees to invite. Another option may be to select another user to host the remainder of the meeting, including a recommendation of another user to take over as host for the remainder of the meeting.

In the illustrated embodiment, a host designation module 410 processes a request from the user device 308A to initiate a virtual meeting request as the host of the virtual meeting. The host designation module 410 initially associates a host device designation with the user device 308A. The host device designation of the user device 308A serves to designate the user of the user device 308A as the host of the virtual meeting.

In the illustrated embodiment, the meeting context data module 402 operates during the virtual meeting to generate meeting context data associated with the virtual meeting. The meeting context data comprises user characteristic data and meeting characteristic data. the meeting context data module 402 stores the user characteristic data and meeting characteristic data in the meeting data database 412. In some embodiments, the meeting context data module 402 generates user characteristic data and organizes the user characteristic data into a registry of profiles for the host, the attendees, and other users. In some embodiments, the meeting context data module 402 generates meeting characteristic data that includes representative states of ongoing virtual meetings. In some embodiments, the meeting and user characteristic data is cognitively evaluated using one or more machine learning techniques for various management aspects of virtual meetings. For example, in some embodiments, the run-over prediction module 404 uses the meeting and user characteristic data to determine run-over likelihood and the host designation module 410 uses the meeting and user characteristic data to identify handoff candidates for hosts/co-hosts recommendations.

In the illustrated embodiment, the run-over prediction module 404 predicts a meeting run-over condition indicative of the virtual meeting continuing past a scheduled end time of the virtual meeting. In some embodiments, the run-over prediction module 404 uses the meeting characteristic data from the meeting context data module 402 to generate a predicted end time for the virtual meeting. In some embodiments, the run-over prediction module 404 predicts the meeting run-over condition by comparing the predicted end time and a scheduled end time.

In the illustrated embodiment, the user ranking module 406 is triggered by the meeting run-over condition being predicted by the run-over prediction module 404. The user ranking module 406 predicts the suitability of other users as hand-off candidates. In some embodiments, the user ranking module 406 ranks users according to their suitability of taking over the hosting/moderation of a virtual meeting based at least in part on the user characteristic data.

In the illustrated embodiment, the VM environment rendering module 408 operates during the virtual meeting to render a display of a virtual meeting environment. In some embodiments, the VM environment rendering module 408 is triggered by the prediction of the meeting run-over condition by the run-over prediction module 404 to render an alert to the host about the likelihood of the virtual meeting running over. In some embodiments, the VM environment rendering module 408 is triggered by the prediction of the meeting run-over condition by the run-over prediction module 404 to render an alert to the other users, including attendees and potential handoff candidates about the likelihood of the virtual meeting running over.

In some embodiments, the VM environment rendering module 408 is triggered by the ranking of the users by user ranking module 406 to render the ranked list in the display of the virtual meeting environment. The VM environment rendering module 408 rendering of the ranked list provides a visual display of the ranked list of hand-off candidates for a replacement host or cohost of a virtual meeting. In some embodiments, the VM environment rendering module 408 rendering of the ranked list includes a visual display of a hand-off suitability score associated with each replacement host/cohost candidate.

In the illustrated embodiment, the visual display of the rendering of the ranked list is displayed for the host on the user device 308A. The visual display includes controls that allow the host to select a replacement host from among the ranked list displayed on the 308A.

In the illustrated embodiment, a host designation module 410 receives the selection of the replacement host from the user device 308A. Upon receiving the replacement host selection, the host designation module 410 associates the host device designation with the user device associated with the user selected as the replacement host. The host device designation of the user device serves to designate the user of the user device as the new host of the virtual meeting.

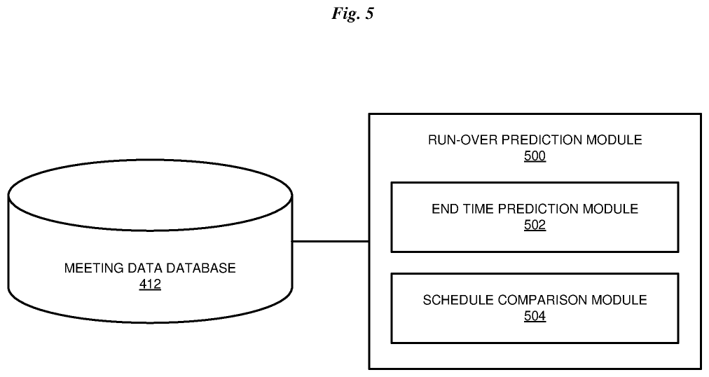

With reference to FIG. 5, this figure depicts a block diagram of an example run-over prediction module 500 in accordance with an illustrative embodiment. In a particular embodiment, the run-over prediction module 500 is an example of the run-over prediction module 404 of FIG. 4.

In some embodiments, the run-over prediction module 500 includes an end time prediction module 502 and a schedule comparison module 504. In alternative embodiments, the virtual meeting module 400 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the end time prediction module 502 predicts a meeting run-over condition indicative of a virtual meeting continuing past a scheduled end time of the virtual meeting or past a time when the host and/or one or more attendees have schedule conflicts that would prevent them from being able to continue with the virtual meeting. In some embodiments, the end time prediction module 502 uses meeting characteristic data and/or user characteristic data from the meeting data database 412 to generate a predicted end time for the virtual meeting. In some embodiments, the schedule comparison module 504 then predicts the meeting run-over condition by comparing the predicted end time and a scheduled end time.

In some embodiments, the end time prediction module 502 uses user characteristic data from the meeting data database 412 and meeting characteristic data that includes representative states of an ongoing virtual meeting to predict a time at which a virtual meeting will end. In some embodiments, the end time prediction module 502 cognitively evaluates the meeting and user characteristic data using one or more machine learning techniques for predicting the end time of an ongoing virtual meeting. For example, in some embodiments, the end time prediction module 502 extracts context features from a registry of profiles for the host, the attendees, and other users, as well as from the representative states of an ongoing meeting. In some such embodiments, the end time prediction module 502 uses the extracted context features as input to a machine learning model that is trained to predict an end time of a virtual meeting. For example, in some embodiments, the meeting context data includes a meeting agenda and audio data of audio from the virtual meeting. In such embodiments, the end time prediction module 502 processes audio of the virtual meeting using NLP to identify a topic of conversation, then uses logistic regression and a meeting agenda to project a likely time that the virtual meeting will end.

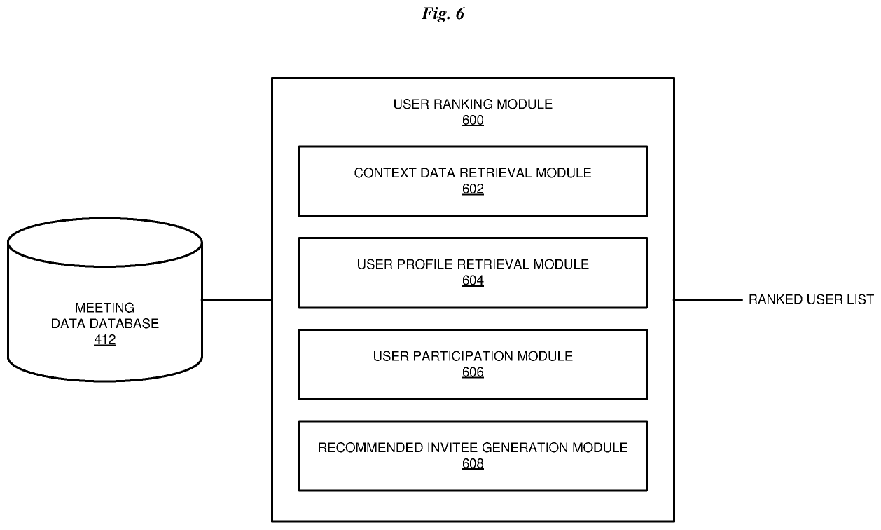

With reference to FIG. 6, this figure depicts a block diagram of an example user ranking module 600 in accordance with an illustrative embodiment. In a particular embodiment, the run-over prediction module 600 is an example of the user ranking module 406 of FIG. 4.

In some embodiments, the user ranking module 600 includes a context data retrieval module 602, a user profile retrieval module 604 a user participation module 606, and a recommended invitee generation module 608. In alternative embodiments, user ranking module 600 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

The user ranking module 600 generates, for the host of a virtual meeting, a recommendation of the suitability of other users as hand-off candidates. In some embodiments, the user ranking module 600 ranks users according to their suitability of taking over the hosting/moderation of a virtual meeting based at least in part on the user characteristic data.

In some embodiments, the context data retrieval module 602 retrieves meeting characteristic data from the meeting data database 412 and the user profile retrieval module 604 retrieves user characteristic data from the meeting data database 412. The user participation module 606 then uses the meeting characteristic data and the user characteristic data to generate hand-off suitability scores for other attendees and/or other users who may or may not be meeting attendees. In some embodiments, the user participation module 606 uses the meeting and user characteristic data to cognitively evaluate the suitability of other users as hand-off candidates using one or more machine learning techniques. The recommended invitee generation module 608 then arranges the users according to degree of suitability and recommends the highest ranking user or users as best host candidates to take over hosting of the virtual meeting.

For example, in some embodiments, the user participation module 606 analyzes an audio feed of audio of the virtual meeting using speech recognition to retrieve speech content data of the audio feed. In some such embodiments, the user participation module 606 inputs the speech content data into a machine learning model. The user participation module 606 generates the speech content data for each user by partitioning the audio feed into clusters of audio feed data associated with respective users attending the virtual meeting. In some embodiments, the user participation module 606 generates attendee participation rankings or scores based on the content and/or speaking duration values for each of the other attendees during the virtual meeting based on the respective clusters of audio feed data. In some embodiments, the recommended invitee generation module 608 arranges the other users into a ranked list according to the participation values or scores.

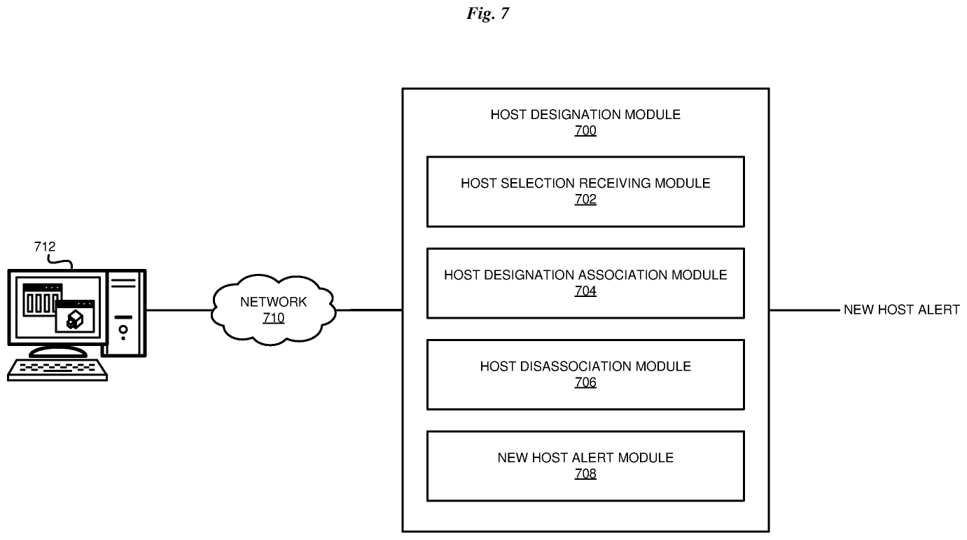

With reference to FIG. 7, this figure depicts a block diagram of an example host designation module 700 in accordance with an illustrative embodiment. In a particular embodiment, the host designation module 700 is an example of the host designation module 410 of FIG. 4.

In some embodiments, the host designation module 700 includes a host selection receiving module 702, a host designation association module 704, a host disassociation module 706, and a new host alert module 708. In alternative embodiments, the host designation module 700 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the host selection receiving module 702 processes request from user devices, such as from the user device user device 712 via network 710, to initiate a virtual meeting request as the host of the virtual meeting. The host designation association module 704 initially stores an association of a host device designation with the user device 712. The host device designation of the user device 712 serves to designate the user of the user device 712 as the host of the virtual meeting.

If a host transfer is initiated for reasons described herein, the host selection receiving module 702 receives the selection of the replacement host from the user device 712. Upon receiving the replacement host selection, the host designation association module 704 associates the host device designation with the user device associated with the user selected as the replacement host. The host device designation of the user device serves to designate the user of the user device as the new host of the virtual meeting. Also, in some embodiments, when a new user is associated with the host designation, this action triggers the host disassociation module 706 to disassociate the host designation from the previous host of the virtual meeting. Also, in some embodiments, when a new user is associated with the host designation, this action triggers the new host alert module 708 to transmit an alert to attendees of the virtual meeting indicative of the selected user being the new host of the virtual meeting.

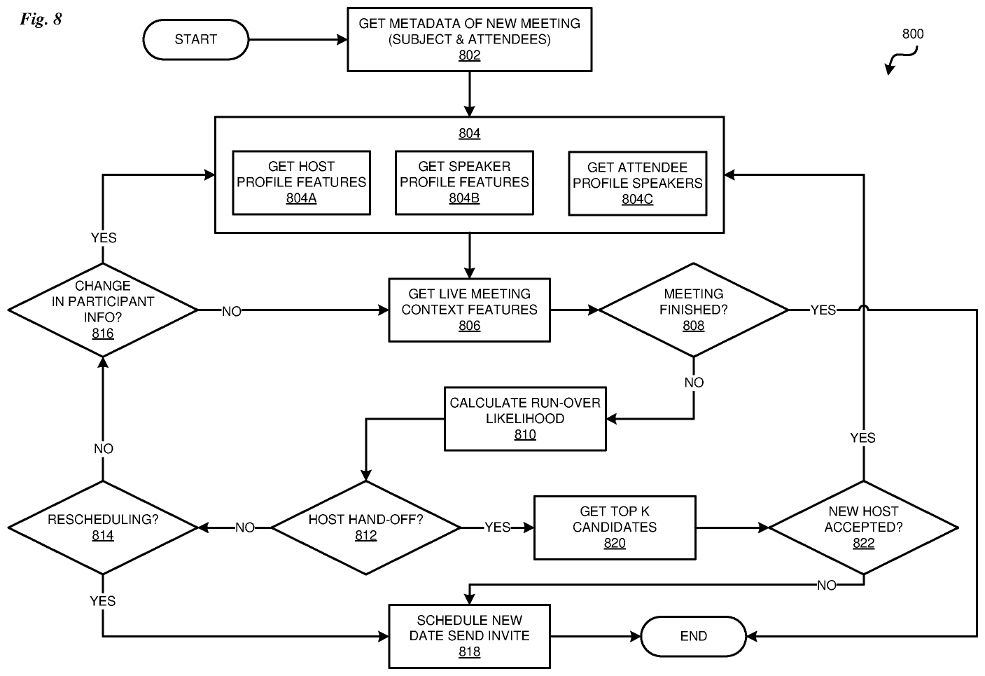

With reference to FIG. 8, this figure depicts a flowchart of an example process for cognitive management of virtual meetings in accordance with an illustrative embodiment. In a particular embodiment, the virtual meeting module 200 carries out the process 800.

At block 802, a virtual meeting is initiated and the process retrieves metadata for the new virtual meeting. In some embodiments, the metadata includes meeting context data that includes user characteristic data and/or meeting characteristic data. In some embodiments, the user characteristic data comprises user profile data from a registry of profiles for the host, the attendees, and other users. In some embodiments, the meeting characteristic data comprises a schedule, a meeting agenda, and during the meeting may further include data representative of states of an ongoing virtual meeting. Next, at block 804, the process extracts context features from a registry of profiles for the host at 804A, any speakers at 804B, and the attendees at 804C.

At block 806, the process extracts context features of the ongoing virtual meeting, for example features associated with representative states of the ongoing meeting, a meeting agenda, and user participation information determined from audio data of audio from the virtual meeting.

At block 808, the process determines if the meeting is over. If so, the process ends. Otherwise, the process continues to block 810 where the process predicts a meeting run-over condition indicative of the virtual meeting continuing past a scheduled end time of the virtual meeting. At block 812, the process offers the host the option of handing off the host duties to another user, or if the user does not wish to hand off host duties, at block 814 the process offers the host the option of rescheduling the remainder of the meeting.

At block 812, if the host selects to hand off host duties, then at block 820 the process predicts the suitability of other users as hand-off candidates. In some embodiments, the process ranks users according to their suitability for taking over the hosting/moderation of a virtual meeting based at least in part on the user characteristic data from block 804 and/or user participation data from block 806. At block 822, the process gives the host the option of accepting another user as a new host. If the new host is accepted, the process returns to block 804 to continue the virtual meeting with the new host. Otherwise, the process continues to block 818 where the remainder of the meeting is rescheduled and invitations are sent to invitees.

At block 814, if the host does not wish to reschedule, the process continues to block 816. At block 816, the process determines whether there has been any change to the participants or attendees of the virtual meeting. If so, the process continues to block 804 to retrieve feature data for any new attendees. Otherwise, the process continues to block 806 to extract updated context features of the ongoing virtual meeting. Also, at block 814, if the host chooses to reschedule, the process continues to block 818 described above, then the process ends.

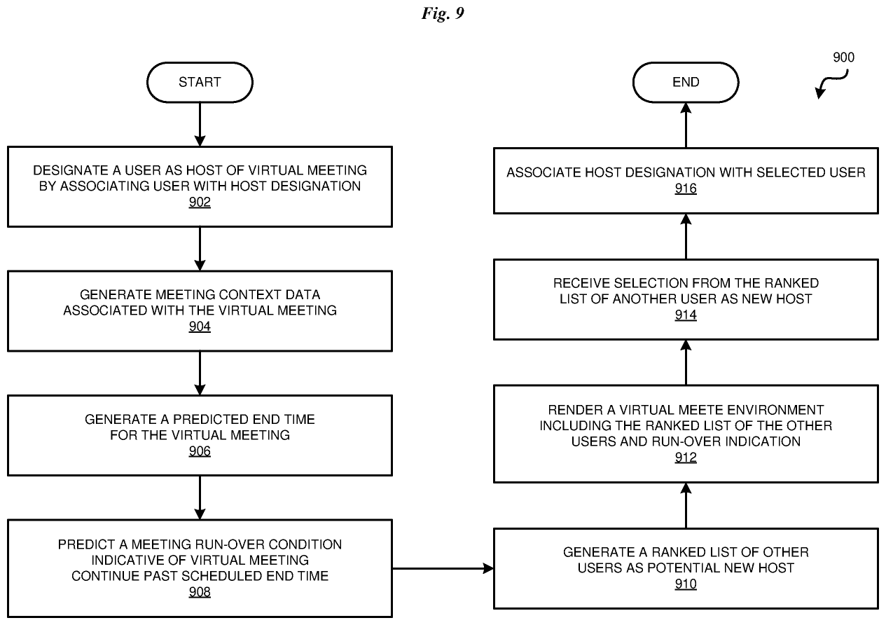

With reference to FIG. 9, this figure depicts a flowchart of an example process 900 for cognitive management of virtual meetings in accordance with an illustrative embodiment. In a particular embodiment, the virtual meeting module 200 carries out the process 900.

At block 902, the process designates a user as the host of the virtual meeting by associating the user with host designation. Next, at block 904, the process generates meeting context data associated with the virtual meeting. Next, at block 906, the process generates a predicted end time for the virtual meeting. Next, at block 908, the process predicts a meeting run-over condition indicative of the virtual meeting continuing past the scheduled end time. Next, at block 910, the process generates a ranked list of other users as potential new hosts. Next, at block 912, the process renders a virtual meeting environment including the ranked list of the other users and run-over indication. Next, at block 914, the process receives a selection from the ranked list of another user as the new host. Next, at block 916, the process associates the host designation with the selected user.

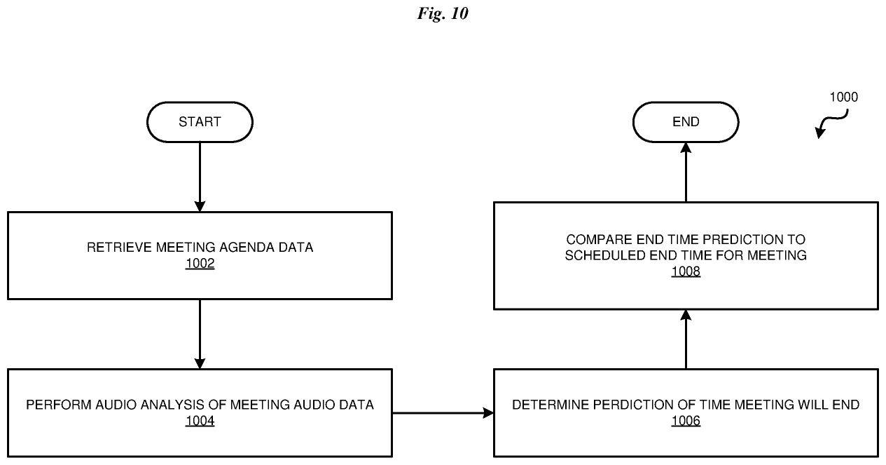

With reference to FIG. 10, this figure depicts a flowchart of an example process 1000 for predicting a meeting run-over condition indicative of a virtual meeting continuing past a scheduled end time of the virtual meeting in accordance with an illustrative embodiment. In a particular embodiment, the run-over prediction module 500 of FIG. 5 carries out the process 1000.

At block 1002, the process retrieves meeting agenda data. Next, at block 1004, the process performs audio analysis of meeting audio data. Next, at block 1006, the process determines a prediction of the time that the virtual meeting will end. Next, at block 1008, the process compares the predicted end time to a scheduled end time from the meeting agenda data. If the predicted end time is past the scheduled end time, then the process predicts that the meeting will run over.

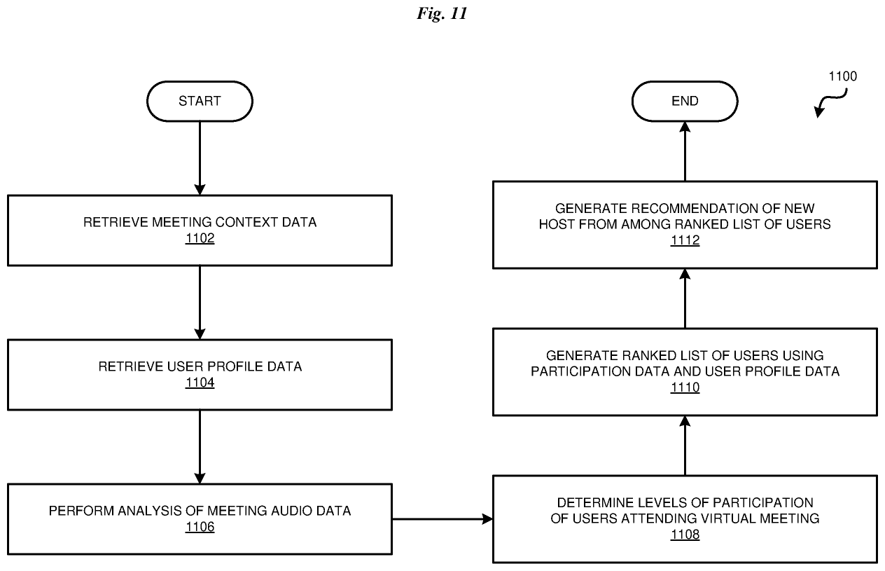

With reference to FIG. 11, this figure depicts a flowchart of an example process 1100 for predicting the suitability of other users as hand-off candidates in accordance with an illustrative embodiment. In a particular embodiment, the user ranking module 600 of FIG. 6 carries out the process 1100.

At block 1102, the process retrieves meeting context data. Next, at block 1104, the process retrieves user profile data. Next, at block 1106, the process performs analysis of meeting audio data. Next, at block 1108, the process determines levels of participation of users attending the virtual meeting based on an analysis of the audio data. Next, at block 1110, the process generates a ranked list of users using participation data and user profile data. Next, at block 1112, the process generates a recommendation of the new host from the top ranked user(s) on the ranked users list.

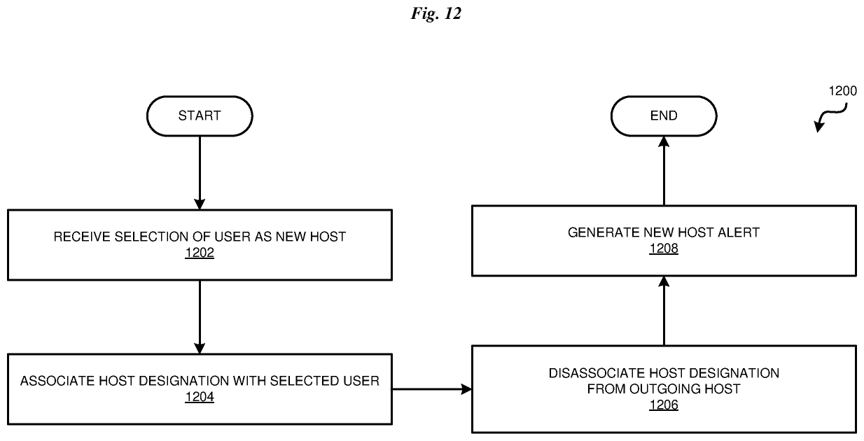

With reference to FIG. 12, this figure depicts a flowchart of an example process 1200 for managing host device designations in accordance with an illustrative embodiment. In a particular embodiment, the host designation module 700 of FIG. 7 carries out the process 700.

At block 1202, the process receives a selection of a user as the new host. Next, at block 1204, the process associates the host designation with a selected user. Next, at block 1206, the process disassociates the host designation from the outgoing host. Next, at block 1208, the process generates a new host alert that is sent to attendees alerting the attendees as to the identity of the new host of the virtual meeting.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of the present invention each have been described by stating their individual advantages, respectively, the present invention is not limited to a particular combination thereof. On the contrary, such embodiments may also be combined in any way and number according to the intended deployment of the present invention without losing their beneficial effects.

What is claimed is:

1. A computer-implemented method comprising:
associating, during a virtual meeting attended by a first user, a host designation with the first user, wherein the host designation designates the first user as the host of the virtual meeting;
generating, during the virtual meeting, meeting context data associated with the virtual meeting,
wherein the meeting context data comprises user characteristic data and meeting characteristic data;
generating a predicted end time for the virtual meeting based at least in part on the meeting characteristic data;
predicting a meeting run-over condition indicative of the virtual meeting continuing past a scheduled end time of the virtual meeting, wherein the predicting of the meeting run-over condition is based at least in part on a comparison of the predicted end time and the scheduled end time;
generating, responsive to predicting the meeting run-over condition, a ranked list of other users based at least in part on the user characteristic data;
rendering, during the virtual meeting as a display to the first user, a virtual meeting environment including the ranked list of the other users and an indication of the meeting run-over condition;
receiving, from the first user, a selection from the ranked list of a second user as a new host of the virtual meeting; and
associating, responsive to receiving the selection of the second user as the new host, the host designation with the second user such that the host designation designates the second user as the host of the virtual meeting.

2. The computer-implemented method according to claim 1, further comprising:
disassociating, responsive to receiving the selection of the second user as the new host, the host designation from the first user of the virtual meeting.

3. The computer-implemented method according to claim 1, further comprising:
transmitting, responsive to associating the host designation with the second user, an alert to attendees of the virtual meeting indicative of the second user being the new host of the virtual meeting.

4. The computer-implemented method according to claim 1, wherein the predicting of the meeting run-over condition comprises inputting agenda data associated with the virtual meeting into a machine learning model.

5. The computer-implemented method according to claim 4, further comprising:
analyzing an audio feed of audio of the virtual meeting using speech recognition to retrieve speech content data of the audio feed.

6. The computer-implemented method according to claim 5, wherein the predicting of the meeting run-over condition comprises inputting the speech content data into the machine learning model.

7. The computer-implemented method according to claim 5, further comprising generating a recommended invitee list from among the other users, wherein the recommended invitee list is indicative of users to invite to a follow-up meeting, and wherein the generating of the recommended invitee list is based at least in part on the speech content data.

8. The computer-implemented method according to claim 5, wherein the generating of the ranked list of the other users is based at least in part on the speech content data.

9. The computer-implemented method according to claim 8, wherein the generating of the ranked list of the other users comprises partitioning the audio feed into clusters of audio feed data associated with respective users attending the virtual meeting.

10. The computer-implemented method according to claim 9, wherein the generating of the ranked list of the other users further comprises:
generating speaking duration values for each of the other users during the virtual meeting based on the respective clusters of audio feed data; and
arranging the other users into the ranked list according to the speaking duration values.

11. The computer-implemented method according to claim 1, wherein the rendering of the virtual meeting environment comprises rendering an indication of the second user being recommended the new host.

12. The computer-implemented method according to claim 1, wherein the generating of the ranked list of other users is based at least in part on respective user profiles.

13. The computer-implemented method according to claim 12, wherein the ranked list of other users comprises at least one attendee of the virtual meeting and at least one non-attendee of the virtual meeting.

14. A computer program product comprising one or more computer readable storage media, and program instructions collectively stored on the one or more computer readable storage media, the program instructions executable by a processor to cause the processor to perform operations comprising:
associating, during a virtual meeting attended by a first user, a host designation with the first user, wherein the host designation designates the first user as the host of the virtual meeting;
generating, during the virtual meeting, meeting context data associated with the virtual meeting,
wherein the meeting context data comprises user characteristic data and meeting characteristic data;
generating a predicted end time for the virtual meeting based at least in part on the meeting characteristic data;
predicting a meeting run-over condition indicative of the virtual meeting continuing past a scheduled end time of the virtual meeting, wherein the predicting of the meeting run-over condition is based at least in part on a comparison of the predicted end time and the scheduled end time;
generating, responsive to predicting the meeting run-over condition, a ranked list of other users based at least in part on the user characteristic data;
rendering, during the virtual meeting as a display to the first user, a virtual meeting environment including the ranked list of the other users and an indication of the meeting run-over condition;
receiving, from the first user, a selection from the ranked list of a second user as a new host of the virtual meeting; and
associating, responsive to receiving the selection of the second user as the new host, the host designation with the second user such that the host designation designates the second user as the host of the virtual meeting.

15. The computer program product of claim 14, wherein the stored program instructions are stored in a computer readable storage device in a data processing system, and wherein the stored program instructions are transferred over a network from a remote data processing system.

16. The computer program product of claim 14, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

17. The computer program product of claim 14, wherein the predicting of the meeting run-over condition comprises inputting agenda data associated with the virtual meeting into a machine learning model.

18. The computer program product of claim 14, wherein the ranked list of other users comprises at least one attendee of the virtual meeting and at least one non-attendee of the virtual meeting.

19. A computer system comprising a processor and one or more computer readable storage media, and program instructions collectively stored on the one or more computer readable storage media, the program instructions executable by the processor to cause the processor to perform operations comprising:
determining a first activity value by comparing frames of a first sharable video stream received from a first device associated with a first participant of a virtual meeting;
generating a first ranked list of activity values, the first ranked list including the first activity value;
identifying the first activity value as a highest ranking activity value in the first ranked list of activity values; and
transmitting, responsive to identifying the first activity value as the highest ranking activity value, the first sharable content to attendees of the virtual meeting.

20. The computer system of claim 19, wherein the ranked list of other users comprises at least one attendee of the virtual meeting and at least one non-attendee of the virtual meeting.
